(19) United States
(12) Patent Application Publication
(10) Pub. No.: US 2026/0018887 A1
(43) Pub. Date: Jan. 15, 2026

(54) THREE-PHASE ADAPTIVE RECLOSING METHOD AND SYSTEM FOR WIND FARM TRANSMISSION LINES BASED ON PARALLEL REACTOR CURRENT

(71) Applicant: Kunming University of Science and Technology, Kunming (CN)

(72) Inventors: Hongchun SHU, Kunming (CN); Yue DAI, Kunming (CN); Yutao TANG, Kunming (CN); Yiming HAN, Kunming (CN); Hongfang ZHAO, Kunming (CN); Weijie LOU, Kunming (CN)

(73) Assignee: Kunming University of Science and Technology, Kunming (CN)

(21) Appl. No.: 19/026,671

(22) Filed: Jan. 17, 2025

(30) Foreign Application Priority Data
Jul. 15, 2024 (CN) 202410940259.8

(51) Int. Cl. H02J 3/00; H02J 3/38

(52) U.S. Cl. CPC H02J 3/00125; H02J 3/0012; H02J 3/381; H02J 2300/28

(57) ABSTRACT

A three-phase adaptive reclosing method and system for wind farm transmission lines based on parallel reactor current is provided. When a phase to phase or three-phase fault occurs in the transmission line, the circuit breakers at both ends trip. The current transformer is used to sample the three-phase current signal of the parallel reactor, calculate the differential mode current of the parallel reactor, and perform zero crossing detection to construct a fault nature identification criterion. The fault nature is determined within the maximum discrimination time limit combined with the sliding time window. For permanent faults, the reclosing device is locked; for transient faults, calculate the time when the fault disappears and determine the reclosing time, and open the reclosing device. The method and system identifies the nature of faults by detecting whether the differential current of parallel reactors crosses the zero axis, with low sampling rate requirements, and small errors.

### CROSS REFERENCE TO THE RELATED APPLICATIONS

This application is based upon and claims priority to Chinese Patent Application No. 202410940259.8, filed on Jul. 15, 2024, the entire contents of which are incorporated herein by reference.

### TECHNOLOGY FIELD

The present invention relates to a three-phase adaptive reclosing method and system for wind farm transmission lines based on parallel reactor current, belonging to the field of power system relay protection.

### BACKGROUND

At present, domestic wind farm power generation units usually choose to install doubly fed wind turbines and permanent magnet direct drive wind turbines, each of which occupies a certain proportion to form a mixed cluster wind turbine.

An automatic reclosing scheme for the current 220 kV wind farm transmission line configuration adopts a fixed delay of closing the two end circuit breakers after the circuit breaker trips. Due to a lack of fault nature discrimination before closing, if the fault still exists at this time, a power electronic equipment in the wind farm will be severely impacted. In addition, long-term operating experience has shown that 90% of faults in transmission lines are transient faults, so most faults do not actually need to wait for a fixed delay to be reclosed. Therefore, it is crucial to study adaptive reclosing strategies for wind farm transmission lines that can reliably identify the nature of faults.

At present, many scholars have conducted extensive research on the reclosing technology of wind power transmission lines and have obtained many valuable results. Some scholars have proposed methods such as “checking the voltage of the busbar without voltage line” and “continuously checking the busbar without voltage” to improve the success rate of reclosing. However, this reclosing plan focuses on whether the reclosing can be successfully initiated, and cannot solve the problem of secondary impact on a wind power transmission system caused by permanent faults. Some scholars have also proposed an adaptive reclosing strategy based on the ratio of active power to reactive power in the fault phase of the wind farm transmission line, but this method requires extracting a large number of frequency components contained in the fault phase power, making filtering difficult. Some scholars have also proposed an active detection based adaptive reclosing method for transmission lines, which injects low current into the transmission line and uses the amplitude integral of the injected current to determine the nature of the fault. This method requires an installation of signal injection equipment and changes to the equipment structure of existing projects, which is costly. Therefore, the existing adaptive reclosing methods for wind farm transmission lines still have shortcomings and urgently need to find new methods suitable for adaptive reclosing of wind farm transmission lines.

### SUMMARY

In view of the above, the present invention provides a three-phase adaptive reclosing method and system for wind farm output lines based on parallel reactor current. By detecting whether the differential mode current of the parallel reactor crosses a zero axis and identifying the fault nature, the sampling rate requirement is low, this error is small, and it is easy to implement; No need to add signal injection equipment, nor to modify the equipment structure of existing projects, with low cost and high universality.

When a phase to phase or three-phase fault occurs in the transmission line of a wind farm, the three-phase circuit breaker trips. For permanent faults, the fault phase current of the parallel reactor oscillates synchronously, and the fault phase difference mode current shows a stable decay state, never crossing the zero axis; For transient faults, when the fault point exists, the differential mode current is consistent with that of permanent faults. After the fault disappears, the differential mode current of the parallel reactor fault is a decaying periodic component with a frequency of ƒ_{D}, which will oscillate around the zero axis. Therefore, the fault nature can be identified by detecting whether the differential mode current of the parallel reactor fault crosses the zero axis during the decay process.

The present invention adopts the following technical solution:

A three-phase adaptive reclosing method for wind farm transmission lines based on parallel reactor current, the specific steps of which are:
Step1: After a phase to phase or three-phase fault occurs in the transmission line, isolating it from the fault. The specific implementation method of this step is: after a phase to phase or three-phase fault occurs in the outgoing line, the circuit breakers installed at both ends of the faulty line trip to isolate the fault.
Step2: Using current transformers to sample the three-phase current signals of parallel reactors;
Step3: Calculating the differential mode current of parallel reactors within the sliding time window. Specifically:
Step3.1: Defining a sliding time window with a time length of Tₛ and a sliding factor of s; The basis for performing this step is that after the fault disappears, the differential current waveform will stably cross the zero axis twice every 20 ms during the decay oscillation process. To ensure that the differential current waveform crosses the zero axis in each sliding window, the sliding window length Tₛ is 20 ms and the sliding factor s is 20 ms
Step3.2: The formula for calculating the differential mode current of a parallel reactor is:

$$[ \begin{matrix}{i}_{α} ( t ) \\ {i}_{β} ( t ) \\ {i}_{γ} ( t )\end{matrix} ] = [ \begin{matrix}1 & - 1 & 0 \\ 1 & 0 & - 1 \\ 0 & 1 & - 1\end{matrix} ] [ \begin{matrix}{i}_{a} ( t ) \\ {i}_{b} ( t ) \\ {i}_{c} ( t )\end{matrix} ] = [ \begin{matrix}{i}_{a} ( t ) ‐ {i}_{b} ( t ) \\ {i}_{a} ( t ) ‐ {i}_{c} ( t ) \\ {i}_{b} ( t ) ‐ {i}_{c} ( t )\end{matrix} ]$$

Among them, i_{α} is the α mode current of the parallel reactor, i_{β} is the β mode current of the parallel reactor, i_{γ} is the γ mode current of the parallel reactor, iₐ is the A-phase current of the parallel reactor, i_{b} is the B-phase current of the parallel reactor, and i_{c} is the C-phase current of the parallel reactor.
Step4: Performing zero crossing detection on the differential mode current of the obtained parallel reactor. The advantage of performing this step is that for permanent faults, the phase difference current of the parallel reactor fault never crosses the zero axis; For transient faults, when the fault point exists, the differential mode current is consistent with that of permanent faults. After the fault disappears, the differential mode current will decay and oscillate around the zero axis. The specific implementation method of this step is:
Step4.1: Calculating the product of the maximum and minimum values of the differential current within the sliding window. The advantage of performing this step is that the differential current product value obtained can determine whether the differential current crosses the zero axis within the time window. The formula is as follows:

$${R}_{k} = {i}_{max , k} \times {i}_{min , k}$$

Among them, k represents the sliding window number; i_{max,k} and i_{min,k}, respectively represent the maximum and minimum values of the differential current within the k-th time window;
Step4.2: Calculating the sign function value of Rₖ within the sliding window. The advantage of performing this step is that if the product value is greater than 0, it means that the differential current within the time window does not cross the zero axis, and the sign function value is 1; If the product value is less than or equal to 0, it means that the differential mode current in the time window crosses the zero axis, and the sign function value is −1. The formula is as follows:

$$sgn ( {R}_{k} ) = \{ \begin{matrix}1 , & {R}_{k} > 0 \\ - 1 , & {R}_{k} ⩽ 0\end{matrix}$$

Step5: Identifying the nature of the fault within the maximum discrimination time limit, and if it is determined to be a permanent fault, output a locking reclosing signal; if it is determined to be a transient fault, proceed to Step 6. The advantage of performing this step is that if the fault still does not disappear after the maximum discrimination time limit detection, it is judged as a permanent fault, avoiding the fault nature recognition system from being in a detection state all the time. Specifically:
Step5.1: Setting the maximum discrimination time limit Tₘₐₓ to 900 ms. The basis for performing this step is that, based on the experience of power grid operation, the fixed time for automatic reclosing is 0.6 s˜1.5 s. Considering the need to ensure that the wind farm can resume operation in the shortest possible time, combined with the time for reactive power compensation equipment to exit operation, the present invention performs reclosing operation within 1 second after the fault occurs. After the fault point extinguishes the arc, it needs to wait for a certain period of time until the insulation medium recovers its insulation strength before reclosing can be carried out. For wind power transmission lines with a voltage level of 220 kV, the insulation recovery time can be taken as 100 ms, that is, the maximum discrimination time limit Tₘₐₓ is 900 ms.
Step5.2: Constructing fault property identification criteria, if the j-th, j+1 and j+2-nd sliding time windows occur within the maximum discrimination time limit, and satisfy:

$$sgn ( {R}_{j} ) = - 1 \& sgn ( {R}_{j + 1} ) = - 1 \& sgn ( {R}_{j + 2} ) = - 1$$

If it is determined as a transient fault, otherwise it is determined as a permanent fault. The advantage of performing this step is that in order to avoid misjudgment caused by the accidental passing of differential current through the zero axis within a sliding time window when the fault point still exists, it is stipulated that the occurrence of three consecutive sliding time windows that meet the identification criteria will be judged as a transient fault.
Step6: Calculating the time when the fault disappears and determine the three-phase reclosing time, and outputting the reclosing signal. Specifically:
Step6.1: According to the sliding window number j obtained in Step5.2, calculating the time when the fault disappears t_{end}. The basis for performing this step is to assume that the fault disappears at the end of the first time window that satisfies the fault nature identification criteria. The calculation formula is:

$${t}_{end} = {jT}_{s} + {t}_{trip}$$

Among them, Tₛ is the length of the sliding time window, taken here as 20 ms,and tₜᵣᵢₚ is the time when the circuit breaker trips;
Step6.2: Calculating the three-phase reclosing time t_{close} based on the arc insulation recovery time Tᵣₑ, and outputting the reclosing signal. The basis for performing this step is that after the fault point extinguishes the arc, it takes a certain amount of time for the arc insulation to recover. For a wind power transmission line with a voltage level of 220 kV, the arc insulation recovery time Tre is taken as 100 ms. The calculation formula for the moment of reclosing is:

$${t}_{close} = {t}_{end} + {T}_{re}$$

A three-phase adaptive reclosing system for wind farm transmission lines based on parallel reactor current, including:
Protection processing module, used to receive protection signals in case of phase to phase or three-phase faults in the transmission line, and to make the circuit breakers at both ends perform corresponding actions;
Data acquisition module, used to obtain digital signals of three-phase current of parallel reactors on the transmission line;
Signal processing module, used to calculate the differential mode current of parallel reactors and perform zero crossing detection on it;
Fault nature discrimination module, used to combine sliding time window to discriminate the fault nature within the maximum discrimination time limit and output the discrimination result;
The reclosing execution module is used to receive the reclosing execution signal or reclosing locking signal output by the fault nature discrimination module, and execute corresponding actions.

The three-phase adaptive reclosing system for wind farm transmission lines based on parallel reactor current is characterized in that the protection processing module specifically includes:
Protect the receiving unit for receiving circuit breaker trip signals;
Protection action unit, used to perform circuit breaker tripping processing.

The three-phase adaptive reclosing system for wind farm transmission lines based on parallel reactor current is characterized in that the data acquisition module specifically includes:
Current measurement unit, used to obtain simulated three-phase current signals of parallel reactors on the transmission line;
The analog-to-digital conversion unit is used to convert the obtained three-phase current analog signal of the parallel reactor into a digital signal.

The three-phase adaptive reclosing system for wind farm transmission lines based on parallel reactor current is characterized in that the signal processing module specifically includes:

Differential to analog conversion unit, used for differential to analog conversion of the obtained three-phase current digital signal of the parallel reactor;
Zero crossing detection unit, used to calculate the product of the maximum and minimum differential current values within the sliding window, and calculate its sign function value.

The three-phase adaptive reclosing system for wind farm transmission lines based on parallel reactor current is characterized in that the fault nature discrimination module specifically includes:
Property discrimination unit, used to construct fault property recognition criteria and combine sliding time windows to discriminate fault properties within the maximum discrimination time limit;
Closing signal unit, used to output closing execution signal or closing locking signal.

The three-phase adaptive reclosing system for wind farm transmission lines based on parallel reactor current is characterized in that the reclosing execution module specifically includes:
Closing start unit, used to start the circuit breakers at both ends of the outgoing line to close again;
Closing locking unit, used to lock the circuit breakers at both ends of the outgoing line to close again.

The beneficial effects of the present invention are:
1. The present invention identifies the nature of faults by detecting whether the differential current of a parallel reactor crosses the zero axis. Changing the sampling frequency does not change the essential characteristics of the differential current waveform crossing the zero axis. Therefore, the present invention has lower requirements for sampling rate and matches the actual engineering sampling frequency. At the same time, the computational complexity is relatively small, making it easy to implement in practical engineering.
2. The sliding window length of the present invention is only 20 ms, which is sufficient to identify the nature of the fault. Therefore, the calculation error for the fault extinguishing time is relatively small, with an error not exceeding 40 ms, that is, two sliding window lengths. Compared with other solutions, the present invention has a significant positive impact on improving the operational stability of wind farms.
3. The present invention does not require the installation of signal injection equipment, nor does it require changes to the structure of existing equipment in the project. It only needs to collect the current value of the parallel reactor to achieve fault nature identification, and has good economic performance.
4. The fault property identification criterion of the present invention does not require setting a setting value, which can effectively avoid the problem of fault property identification errors caused by differences in setting values.

### BRIEF DESCRIPTION OF THE DRAWINGS

FIG. 1 is a topology diagram of the simulation system of the present invention;

FIG. 2 is a flowchart of the adaptive reclosing process of the present invention;

FIG. 3 is a functional block diagram of the adaptive reclosing system of the present invention;

FIGS. 4A-4C are schematic diagrams of the fault recognition results in Example 1 of the present invention;

FIG. 4A shows the waveform of the three-phase current of the parallel reactor in Example 1 of the present invention;

FIG. 4B shows the waveform of the alpha mode current of the parallel reactor in Example 1 of the present invention;

FIG. 4C is a schematic diagram of the sliding time window discrimination results in Example 1 of the present invention;

FIGS. 5A-5C are schematic diagrams of the fault recognition results in Example 2 of the present invention;

FIG. 5A shows the waveform of the three-phase current of the parallel reactor in Example 2 of the present invention;

FIG. 5B shows the waveform of the alpha mode current of the parallel reactor in Example 2 of the present invention;

FIG. 5C is a schematic diagram of the sliding time window discrimination results in Example 2 of the present invention;

### DETAILED DESCRIPTION OF THE EMBODIMENTS

The present invention will be further explained in conjunction with the accompanying drawings and specific embodiments.

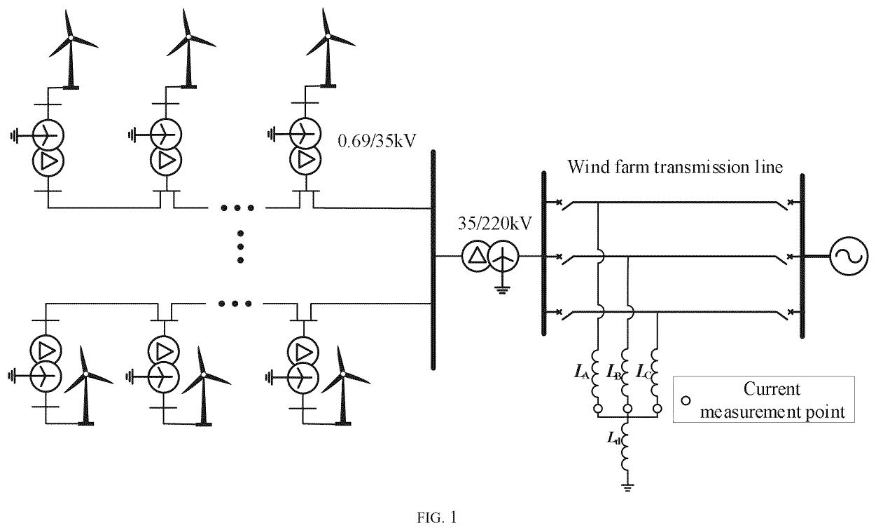

Example 1: The topology of the wind farm's AC transmission system is shown in FIG. 1. Among them, the length of the transmission line is 200 km, and overhead transmission lines are used for power transmission. The inductance of the parallel reactor is taken as L_{A}=L_{B}=L_{C}=6.4203H, the inductance of the neutral point small reactance is taken as L_{d}=1.7504H, and the main transformer between the wind farm collection line and the output line is 220/35 kV. Line parameters: R₁=0.0103Ω/km, R₀=0.3156Ω/km;L₁=0.9694 mH/km,L₀=3.156 mH/km;C₁=0.0122 μF/km,C₀=0.00834 μF/km. At the relative zero moment, an ABG fault occurs at a distance of 80 km from the station side of the transmission line, with a transient fault nature (transition resistance of 50 Ω, fault duration of 386 ms) and a sampling rate of 10 kHz.

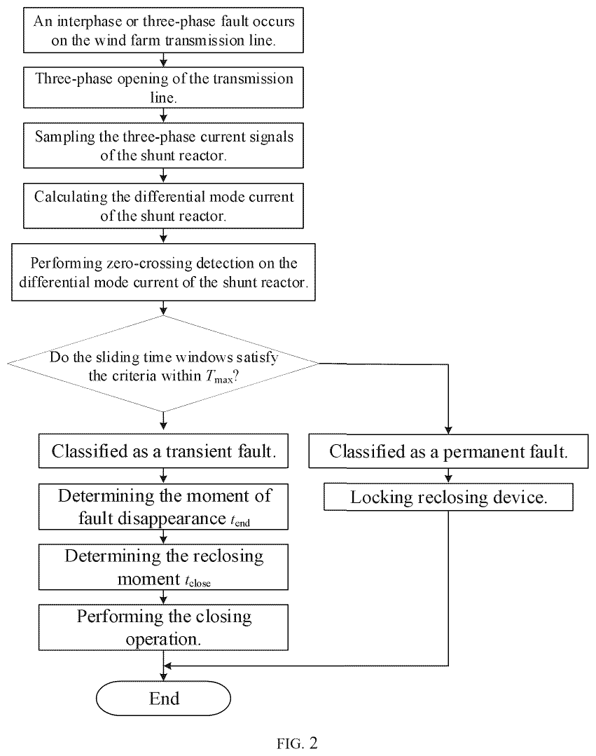

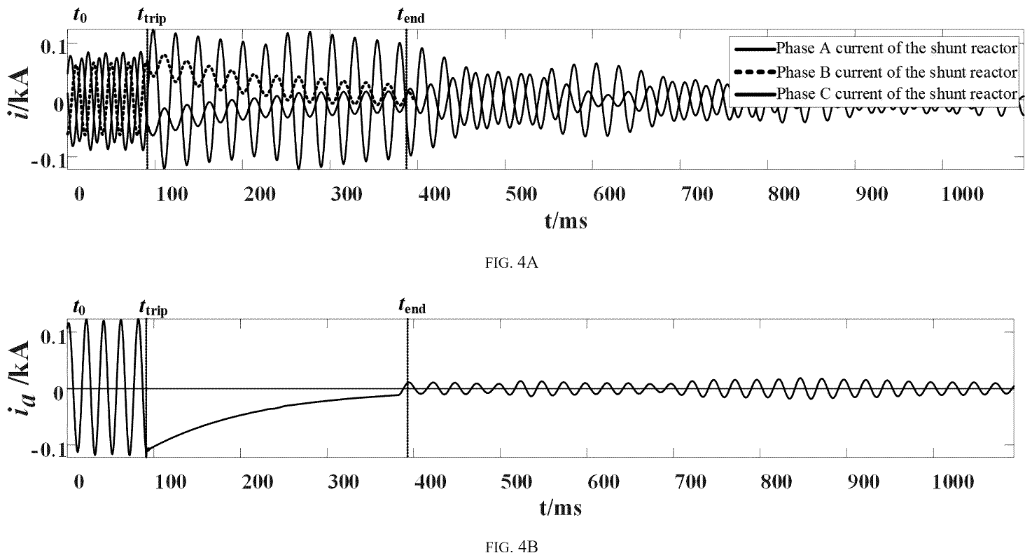

A three-phase adaptive reclosing method for wind farm transmission lines based on parallel reactor current. FIG. 2 shows the workflow of the present invention, and the specific implementation steps are as follows:
Step 1: After an ABG fault occurs on the outgoing line at t₀=0 ms, the circuit breakers installed at both ends of the faulty line trip three phases at tₜᵣᵢₚ=93 ms to isolate the fault.
Step 2: Using a current transformer to sample the three-phase current signal of the parallel reactor. In this embodiment, the three-phase current signal of the parallel reactor is shown in FIG. 4A.
Step 3: Calculating the differential mode current of the parallel reactor within the sliding time window. Specifically:
Step 3.1: Defining a sliding time window with a time length Tₛ of 20 ms and a sliding factor s of 20 ms.
Step 3.2: Calculating the differential mode current of the parallel reactor.

$$[ \begin{matrix}{i}_{α} ( t ) \\ {i}_{β} ( t ) \\ {i}_{γ} ( t )\end{matrix} ] = [ \begin{matrix}1 & - 1 & 0 \\ 1 & 0 & - 1 \\ 0 & 1 & - 1\end{matrix} ] [ \begin{matrix}{i}_{a} ( t ) \\ {i}_{b} ( t ) \\ {i}_{c} ( t )\end{matrix} ] = [ \begin{matrix}{i}_{a} ( t ) ‐ {i}_{b} ( t ) \\ {i}_{a} ( t ) ‐ {i}_{c} ( t ) \\ {i}_{b} ( t ) ‐ {i}_{c} ( t )\end{matrix} ]$$

Among them, i_{α} is the α mode current of the parallel reactor, i_{β} is the β mode current of the parallel reactor, i_{γ} is the γ mode current of the parallel reactor, iₐ is the A-phase current of the parallel reactor, i_{b} is the B-phase current of the parallel reactor, and i_{c} is the C-phase current of the parallel reactor.

In this embodiment, the differential mode current of the parallel reactor is shown in FIG. 4B.
Step 4: Performing zero crossing detection on the differential current of the obtained parallel reactor. The specific implementation method is:
Step 4.1: Calculating the product of the maximum and minimum values of the differential current within the sliding window.

$${R}_{k} = {i}_{max , k} \times {i}_{min , k}$$

Among them, k represents the sliding window number; i_{max,k} and i_{min,k}, respectively represent the maximum and minimum values of the differential current within the k-th time window;
Step4.2: Calculating the sign function value of Rₖ within the sliding window:

$$sgn ( {R}_{k} ) = \{ \begin{matrix}1 , & {R}_{k} > 0 \\ - 1 , & {R}_{k} ⩽ 0\end{matrix}$$

Step 5: Determining the nature of the fault within the maximum discrimination time limit. If it is determined to be a permanent fault, output a locking reclosing signal; If it is determined to be a transient fault, proceed to Step 6.
Step 5.1: Setting the maximum discrimination time limit Tₘₐₓ to 900 ms.
Step 5.2: Constructing fault property identification criteria. If the j-th, j+1, and j+2-nd sliding time windows occur within the maximum discrimination time limit, they meet the following criteria:

$$sgn ( {R}_{j} ) = - 1 \& sgn ( {R}_{j + 1} ) = - 1 \& sgn ( {R}_{j + 2} ) = - 1$$

If it is determined as a transient fault, otherwise it is determined as a permanent fault. In this embodiment, the sliding time window discrimination result is shown in FIG. 4C. For the first time, the 15-th time window sign function value is −1, and the 16-th and 17-th time window sign function values are also −1, resulting in j=15.
Step 6: Calculating the time when the fault disappears and determine the three-phase reclosing time, and outputting the reclosing signal. Specifically:
Step 6.1: Based on the sliding window number j=15 obtained in Step 5.2, calculating the time when the fault disappears, denoted as t_{end}. The calculation formula is:

$${t}_{end} = {jT}_{s} + {t}_{trip} = 15 \times 20 + 93 = 393 ms$$

Among them, Tₛ=20 ms is the length of the sliding time window, and tₜᵣᵢₚ=93 ms is the time when the circuit breaker trips.

In this embodiment, the calculated fault duration is 393 ms, and the actual fault disappearance time is 386 ms, with a calculation error of only 7 ms.
Step 6.2: Based on the arc insulation recovery time Tᵣₑ=100 ms, calculating the three-phase reclosing time t_{close}. and outputting the reclosing signal. The calculation formula for the moment of reclosing is:

$${t}_{close} = {t}_{end} + {T}_{re} = 393 + 100 = 493 ms$$

After 493 ms of the fault, a closing signal is output, and the three-phase circuit breakers at both ends of the wind power transmission line are closed, restoring power supply to the system.

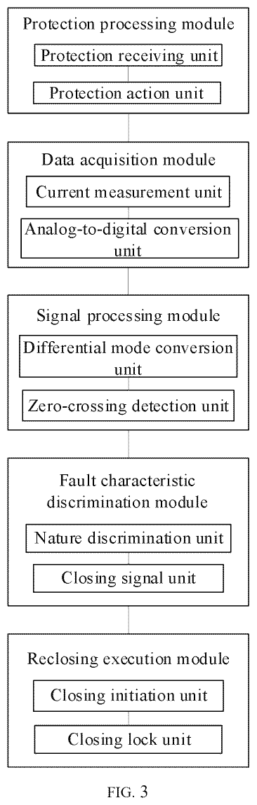

FIG. 3 is a functional block diagram of a three-phase adaptive reclosing system for wind farm transmission lines based on parallel reactor current provided by the present invention, including:
Protection processing module, used to receive protection signals in case of phase to phase or three-phase faults in the transmission line, and to make the circuit breakers at both ends perform corresponding actions;
Data acquisition module, used to obtain digital signals of three-phase current of parallel reactors on the transmission line;
Signal processing module, used to calculate the differential mode current of parallel reactors and perform zero crossing detection on it;
Fault nature discrimination module, used to combine sliding time window to discriminate the fault nature within the maximum discrimination time limit and output the discrimination result;
The reclosing execution module is used to receive the reclosing execution signal or reclosing locking signal output by the fault nature discrimination module, and execute corresponding actions.

The three-phase adaptive reclosing system for wind farm transmission lines based on parallel reactor current is characterized in that the protection processing module specifically includes:
Protecting the receiving unit for receiving circuit breaker trip signals;
Protection action unit, used to perform circuit breaker tripping processing.

The three-phase adaptive reclosing system for wind farm transmission lines based on parallel reactor current is characterized in that the data acquisition module specifically includes:
Current measurement unit, used to obtain simulated three-phase current signals of parallel reactors on the transmission line;
The analog-to-digital conversion unit is used to convert the obtained three-phase current analog signal of the parallel reactor into a digital signal.

The three-phase adaptive reclosing system for wind farm transmission lines based on parallel reactor current is characterized in that the signal processing module specifically includes:
Differential to analog conversion unit, used for differential to analog conversion of the obtained three-phase current digital signal of the parallel reactor;
Zero crossing detection unit, used to calculate the product of the maximum and minimum differential current values within the sliding window, and calculate its sign function value.

The three-phase adaptive reclosing system for wind farm transmission lines based on parallel reactor current is characterized in that the fault nature discrimination module specifically includes:
Property discrimination unit, used to construct fault property recognition criteria and combine sliding time windows to discriminate fault properties within the maximum discrimination time limit;
Closing signal unit, used to output closing execution signal or closing locking signal.

The three-phase adaptive reclosing system for wind farm transmission lines based on parallel reactor current is characterized in that the reclosing execution module specifically includes:
Closing start unit, used to start the circuit breakers at both ends of the outgoing line to close again;
Closing locking unit, used to lock the circuit breakers at both ends of the outgoing line to close again.

Example 2: The topology of the wind farm's AC transmission system is shown in FIG. 1. Among them, the length of the transmission line is 200 km, and overhead transmission lines are used for power transmission. The inductance of the parallel reactor is taken as L_{A}=L_{B}=L_{C}=6.4203H, the inductance of the neutral point small reactance is taken as L_{d}=1.7504H, and the main transformer between the wind farm collection line and the output line is 220/35 kV. Line parameters: R₁=0.0103Ω/km, R₀=0.3156Ω/km;L₁=0.9694 mH/km,L₀=3.156 mH/km;C₁=0.0122 μF/km,C₀=0.0 0834 μF/km. At the relative zero moment, an ABG fault occurs at a distance of 80 km from the station side of the transmission line, with a permanent fault nature (transition resistance of 50 Ω) and a sampling rate of 10 kHz.

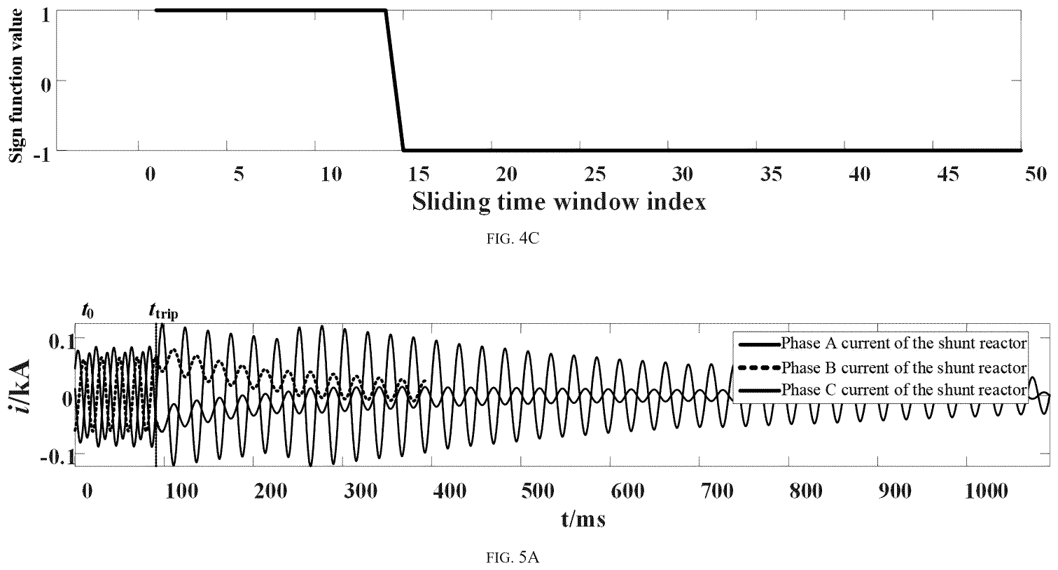

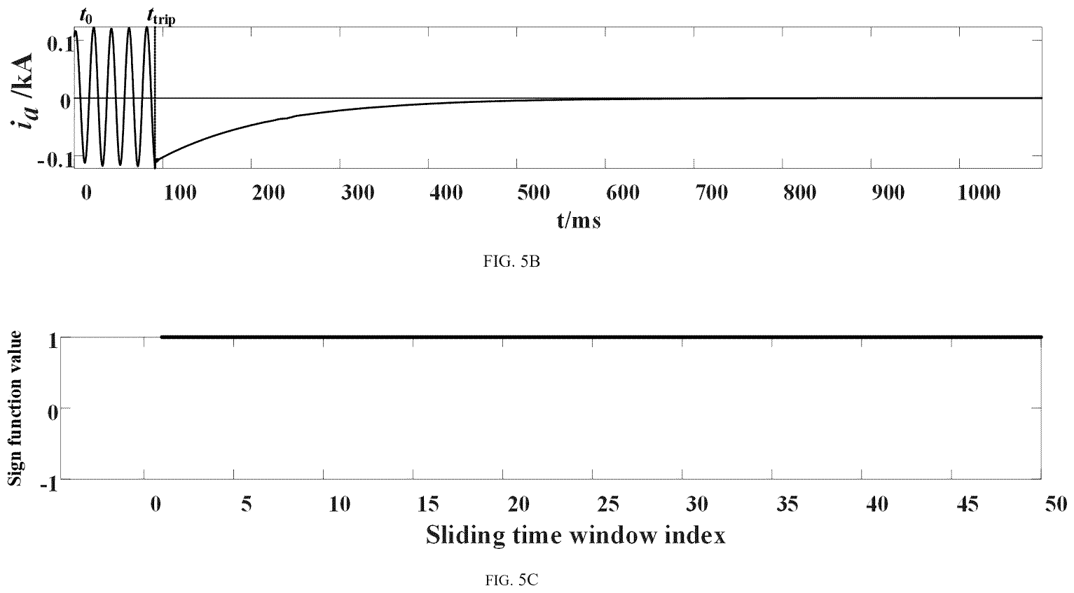

A three-phase adaptive reclosing method for wind farm transmission lines based on parallel reactor current. FIG. 2 shows the workflow of the present invention, and the specific implementation steps are as follows:
Step 1: After an ABG fault occurs on the outgoing line at t₀=0 ms, the circuit breakers installed at both ends of the faulty line trip three phases at tₜᵣᵢₚ=93 ms to isolate the fault.
Step 2: Using a current transformer to sample the three-phase current signal of the parallel reactor. In this embodiment, the three-phase current signal of the parallel reactor is shown in FIG. 5A.
Step 3: Calculating the differential mode current of the parallel reactor within the sliding time window. Specifically:
Step 3.1: Defining a sliding time window with a time length Tₛ of 20 ms and a sliding factor s of 20 ms.
Step 3.2: Calculating the differential mode current of the parallel reactor.

$$[ \begin{matrix}{i}_{α} ( t ) \\ {i}_{β} ( t ) \\ {i}_{γ} ( t )\end{matrix} ] = [ \begin{matrix}1 & - 1 & 0 \\ 1 & 0 & - 1 \\ 0 & 1 & - 1\end{matrix} ] [ \begin{matrix}{i}_{a} ( t ) \\ {i}_{b} ( t ) \\ {i}_{c} ( t )\end{matrix} ] = [ \begin{matrix}{i}_{a} ( t ) ‐ {i}_{b} ( t ) \\ {i}_{a} ( t ) ‐ {i}_{c} ( t ) \\ {i}_{b} ( t ) - {i}_{c} ( t )\end{matrix} ]$$

Among them, i_{α} is the a mode current of the parallel reactor, i_{β} is the β mode current of the parallel reactor, i_{γ} is the γ mode current of the parallel reactor, iₐ is the A-phase current of the parallel reactor, i_{b} is the B-phase current of the parallel reactor, and i_{c} is the C-phase current of the parallel reactor.

In this embodiment, the differential mode current of the parallel reactor is shown in FIG. 5B.
Step 4: Performing zero crossing detection on the differential current of the obtained parallel reactor. The specific implementation method is:
Step 4.1: Calculating the product of the maximum and minimum values of the differential current within the sliding window.

$${R}_{k} = {i}_{max , k} \times {i}_{min , k}$$

Among them, k represents the sliding window number; i_{max,k} and i_{min,k}, respectively represent the maximum and minimum values of the differential current within the k-th time window;
Step4.2: Calculating the sign function value of Rₖ within the sliding window:

$$sgn ( {R}_{k} ) = \{ \begin{matrix}1 , & {R}_{k} > 0 \\ - 1 , & {R}_{k} ⩽ 0\end{matrix}$$

Step 5: Determining the nature of the fault within the maximum discrimination time limit. If it is determined to be a permanent fault, output a locking reclosing signal; if it is determined to be a transient fault, proceed to Step 6.
Step 5.1: Setting the maximum discrimination time limit Tₘₐₓ to 900 ms.
Step 5.2: Constructing fault property identification criteria. If the j-th, j+1, and j+2-nd sliding time windows occur within the maximum discrimination time limit, they meet the following criteria:

$$sgn ( {R}_{j} ) = - 1 \& sgn ( {R}_{j + 1} ) = - 1 \& sgn ( {R}_{j + 2} ) = - 1$$

If it is determined as a transient fault, otherwise it is determined as a permanent fault. In this embodiment, the sliding time window discrimination result is shown in FIG. 5C. From the moment of tripping of the circuit breaker, the differential mode current of the fault phase parallel reactor steadily decays and does not cross the zero axis until the maximum judgment time limit. There are no consecutive three times window sign function values of −1, which do not meet the fault nature identification criteria. The fault nature is identified as a permanent fault, and a locking signal is output without reclosing operation.

The technical features of a three-phase adaptive reclosing system for wind farm transmission lines based on parallel reactor current in this embodiment are the same as those in embodiment 1, and will not be repeated here.

At present, the reclosing device installed on the transmission line project of wind farms often adopts the traditional reclosing strategy, which means that when the transmission line fails and the circuit breaker trips, regardless of whether the transmission line experiences a transient or permanent fault, it will perform indiscriminate reclosing after a fixed delay. If it coincides with a permanent fault or closes at the moment when the secondary arc is not extinguished, the reclosing fails, causing a secondary impact on the system and affecting its stable operation. The present invention can correctly identify the nature of the fault before the circuit breaker recloses. If it is identified as a permanent fault, it will be locked and reclosed; If it is identified as a transient fault, calculate the time when the fault disappears, determine the specific reclosing time, and restore power supply in a timely manner, which is of great significance for the reliable operation of the wind power transmission system and the safety and stability of the power equipment.

The specific embodiments of the present invention have been described in detail above in conjunction with the accompanying drawings. However, the present invention is not limited to the above embodiments, and various changes can be made within the knowledge scope of those skilled in the art without departing from the purpose of the present invention.

1. A three-phase adaptive reclosing method for wind farm transmission lines based on parallel reactor current, comprising the following steps:
Step 1: after a phase to phase or three-phase fault occurs in a transmission line, isolating the transmission line from the phase to phase or three-phase fault;
Step 2: using current transformers to sample three-phase current signals of parallel reactors;
Step 3: calculating a differential mode current of the parallel reactors within a sliding time window;
Step 4: performing zero crossing detection on the differential mode current of the parallel reactors;
Step 5: identifying a nature of the phase to phase or three-phase fault within a maximum discrimination time limit, and when the phase to phase or three-phase fault is determined to be a permanent fault, outputting a locking reclosing signal; when the phase to phase or three-phase fault is determined to be a transient fault, proceeding to Step6; and
Step 6: calculating a time when the phase to phase or three-phase fault disappears and determining a three-phase reclosing time, and outputting a reclosing signal;
wherein Step 4 comprises:
Step 4.1: calculating a product of maximum and minimum values of the differential mode current within the sliding time window:
$${R}_{k} = {i}_{max , k} \times {i}_{min , k}$$
wherein k represents a sliding window number; i_{max,k} and i_{min,k} respectively represent the maximum and minimum values of the differential mode current within a k-th time window; and
Step 4.2: calculating a sign function value of Rₖ within the sliding time window:
$$sgn ( {R}_{k} ) = \{ \begin{matrix}1 , & {R}_{k} > 0 \\ - 1 , & {R}_{k} ⩽ 0\end{matrix} ;$$
wherein Step 5 comprises:
Step 5.1: setting the maximum discrimination time limit Tₘₐₓ; and
Step 5.2: constructing fault nature identification criteria, when j-th, j+1 and j+2-nd sliding time windows occur within the maximum discrimination time limit, and satisfy:
$$sgn ( {R}_{j} ) = - 1 \& sgn ( {R}_{j + 1} ) = - 1 \& sgn ( {R}_{j + 2} ) = - 1$$
the phase to phase or three-phase fault is determined as the transient fault, otherwise the phase to phase or three-phase fault is determined as the permanent fault; wherein Step 6 comprises:
Step 6.1: according to the sliding window number j obtained in Step 5.2, calculating the time t_{end} when the phase to phase or three-phase fault disappears:
$${t}_{end} = {jT}_{s} + {t}_{trip}$$
wherein Tₛ is a length of the sliding time window, and tₜᵣᵢₚ is the time when a circuit breaker trips; and
Step 6.2: calculating the three-phase reclosing time t_{close} based on an arc insulation recovery time Tᵣₑ, and outputting the reclosing signal:
$${t}_{close} = {t}_{end} + {T}_{re} .$$

2. The three-phase adaptive reclosing method for the wind farm transmission lines based on the parallel reactor current according to claim 1, wherein in Step1, after the phase to phase or three-phase fault occurs in the transmission line, the circuit breakers installed at both ends of a fault line trip to isolate the phase to phase or three-phase fault.

3. The three-phase adaptive reclosing method for the wind farm transmission lines based on the parallel reactor current according to claim 1, wherein Step3 comprises:
Step3.1: defining a sliding time window with a time length of Tₛ and a sliding factor of s;
Step3.2: calculating the differential mode current of a parallel reactor by a following formula:
$$[ \begin{matrix}{i}_{α} ( t ) \\ {i}_{β} ( t ) \\ {i}_{γ} ( t )\end{matrix} ] = [ \begin{matrix}1 & - 1 & 0 \\ 1 & 0 & - 1 \\ 0 & 1 & - 1\end{matrix} ] [ \begin{matrix}{i}_{a} ( t ) \\ {i}_{b} ( t ) \\ {i}_{c} ( t )\end{matrix} ] = [ \begin{matrix}{i}_{a} ( t ) ‐ {i}_{b} ( t ) \\ {i}_{a} ( t ) ‐ {i}_{c} ( t ) \\ {i}_{b} ( t ) - {i}_{c} ( t )\end{matrix} ]$$
wherein i_{α} is an α mode current of the parallel reactor, i_{β} is a β mode current of the parallel reactor, i_{γ} is a y mode current of the parallel reactor, iₐ is an A-phase current of the parallel reactor, i_{b} is a B-phase current of the parallel reactor, and i_{c} is a C-phase current of the parallel reactor.

4. A system for implementing the three-phase adaptive reclosing method for the wind farm transmission lines based on the parallel reactor current according to claim 1, comprising:
a protection processing module, used to receive protection signals in case of the phase to phase or three-phase fault in the transmission line, and to cause the circuit breakers at both ends to perform fault isolation actions;
a data acquisition module, used to obtain digital signals of three-phase current of the parallel reactors on the transmission line;
a signal processing module, used to calculate the differential mode current of the parallel reactors and perform zero crossing detection on the differential mode current;
a fault nature discrimination module, used to combine the sliding time window to discriminate a fault nature within the maximum discrimination time limit and output a discrimination result; and
a reclosing execution module, used to receive a reclosing execution signal or reclosing locking signal output by the fault nature discrimination module, and executing corresponding actions.

5. The system according to claim 4, wherein the protection processing module comprises:
a protection receiving unit, used to receive circuit breaker trip signals; and
a protection action unit, used to perform circuit breaker tripping processing.

6. The system according to claim 4, wherein the data acquisition module comprises:
a current measurement unit, used to obtain a three-phase current analog signal of the parallel reactors on the transmission line; and
an analog-to-digital conversion unit, used to convert the three-phase current analog signal of the parallel reactors into a digital signal.

7. The system according to claim 4, wherein the signal processing module comprises:
a differential to analog conversion unit, used for differential to analog conversion of a three-phase current digital signal of the parallel reactors; and
a zero crossing detection unit, used to calculate the product of the maximum and minimum values of the differential mode current within the sliding time window, and calculating a sign function value of the product.

8. The system according to claim 4, wherein the fault nature discrimination module comprises:
a nature discrimination unit, used to construct the fault nature identification criteria and combine the sliding time window to discriminate the fault nature within the maximum discrimination time limit; and
a closing signal unit, used to output a reclosing execution signal or a reclosing locking signal.

9. The system according to claim 4, wherein the reclosing execution module comprises:
a reclosing start unit, used to start the circuit breakers at both ends of the transmission line to close again; and
a reclosing locking unit, used to lock the circuit breakers at both ends of the transmission line to close again.
